(19) United States
(12) Patent Application Publication
(10) Pub. No.: US 2007/0236502 A1
(43) Pub. Date: Oct. 11, 2007

(54) Generic visualization system

(76) Inventors: Paul C. Huang, Circle Pines, MN (US); Christopher A. Holmes, Champlin, MN (US); Jeffrey M.R. Wolff, Champlin, MN (US); Daniel J. Challou, White Bear Township, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/784,522

(22) Filed: Apr. 6, 2007

Related U.S. Application Data
(60) Provisional application No. 60/790,262, filed on Apr. 7, 2006.

(51) Int. Cl. G06G 7/48

(52) U.S. Cl. 345/473; 703/6

(57) ABSTRACT

The combination of complex physical simulations and realistic real-time interactive virtual environments provides engineers with a means to test the design in various environments before finishing the final products, and program management with a means for better communication and measurement of progress. The present invention provides a system that combines complicated physical simulations with a real-time visualization software tool, and displays the results in realistic 3D environments. The Generic Visualization System (GVS) displays the combined results of many different simulation programs, including several Semi-Automated Forces (SAF) variations (e.g., OneSAF, JSAF, and others), simultaneously.

### RELATED APPLICATION

The present application claims the benefit of U.S. Provisional Application No. 60/790,262 filed Apr. 7, 2006, which is incorporated herein in its entirety by reference.

### FIELD OF THE INVENTION

The present invention provides a system that combines complex physical simulations with a real-time visualization software tool, and displays the results in realistic simulated 3D environments.

### BACKGROUND OF THE INVENTION

The fast advance of micro-electronics and software technology has provided many new tools for modeling and simulation. Using digital computers for modeling and simulation started as early as the days when the digital computer was created. Using computers, almost all dynamic equations can be solved numerically. All physical and behavior attributes of a model in their digital representation exist in the computer software, and hence can be manipulated digitally. For example, models of physics and behavioral based systems can be tested in a computer generated virtual, digital world in the same manner as the real systems are tested in the real world.

In the past, use of computers for modeling and simulation had been reserved for only a few applications, due to the associated high cost in equipment and manpower involved. The proliferation and popularity of computer technology have helped reduce the computational and actual cost of computing to almost negligible amounts, and enabled solving even very complex numerical problems. Complicated physics and behavioral based systems can now be digitally simulated in an accurate, rapid and economical manner.

Demonstrating simulation results using computer generated visualization is a very significant improvement over the old approaches, which included fumbling through vast arrays of data in various formats, such as numbers, tables and graphs. These new approaches use real-time display of 3D environments or re-play of simulation results in the same manner as showing a movie. This would enable even a layman to understand what is going on and what the simulation is about. These techniques have been used on many occasions with great success.

To depict the results of computer simulation using computer-generated visualization entails many technical difficulties. A physics-based event is time-driven, and in each time interval there may be several events happening simultaneously. A single behavior based action may trigger multiple simultaneous responses. For complicated phenomena in the real world, nature takes its own course, but each single pipe arithmetic logic unit can only handle one event at a time. For a very complicated simulation, the computer has to handle a plethora of events within very short periods of time, which puts a heavy burden on computational processing power. Also, the computer graphics should have the capability of providing the operator(s) with a specific or multiple world views. Even within a single view there may be several simulated objects and events for which the dynamics, kinematics and behavior must be addressed. To properly simulate all entities and their corresponding interactions, the laws of physics as configured in the simulation environment setup must be applied at each instance in time. For a computational intense scenario, the amount of processing power needed between time steps is longer, compared to those scenarios, where there is not much interaction. Without changing the fidelity of the simulation, the uneven time steps would cause serious frame rate reductions and irregularities.

To handle computer visualization, software developers have encountered a serious problem, which is that there is no industry standard for frame rates, as there is in the movie industry. Technically, for black-and-white movies, a 16-frame per second is the industry standard, and a 24-frame per second is required for color movies. An ad hoc standard based on common agreement has been set at 30 frames per second, but this frame rate, even though difficult to achieve, still leaves room for improvement. The variation in wall clock time between each rendered frame for a single view will cause display instabilities, such as erratic movement of objects, even if there is not a single mistake or error in the numerical computations. Another difficulty is that each simulated event is unique and typically non deterministic; it contains different objects, performs several functions and may reside in different environments. To show this simulation graphically, the simulation entity repository has to be large enough to contain all the visualization elements.

Computer-generated visualization has gained popularity as computer technology has been rapidly advancing for the last two decades. Game and entertainment industries have contributed significantly in this area. It is not uncommon today to find that the most advanced computing equipment is used in the gaming and entertainment industries. This trend has allowed both the computer graphics hardware and software technology to expand its horizon. This new development also has significant impact on the traditional users of computer graphics and visualization. Compared with other heavy users of computer visualization, such as the auto and aerospace industry, the new generation of computer graphics software and hardware used by the gaming and entertainment industries is cheaper and more compact, but the results are not inferior to its complex and expensive counter parts. The applications of computer graphics in the traditional industries, in addition to the design and analysis, have been expanded to many new areas such as training and trainer development, marketing and concept generation, just to name a few. The range of new application is only limited by the imagination of the users. There is, however, a significantly different requirement between the entertainment industry and those of traditional industries in using computer visualization.

For the visualization of complex objects, it is not uncommon for a single frame to consist of more than one million polygons. To handle this large amount of polygons, various optimization techniques have been developed. These techniques, in theory, can handle any finite number of polygons. In real-time visualization, the ad hoc 30-frame-per-second constraint put a hard requirement on both computer hardware and software. In the movie industry, it is a standard practice to use rendering farms executing distributed rendering batch jobs. A single frame of a view may take more than one hour of computer processing time for complex scenes. Once the rendering of the individual frames has been completed, the frames are combined into a movie clip. Real-time visualization does not have the luxury of batch rendering. The 30-frame-per-second frame rate has to be followed rigorously and delays in rendering are not acceptable.

Most of the time, real-time visualization needs to be generated on the fly in real-time. In these cases the computations and data handling have to be performed faster than the simulated event in the real world but the display has to visualize the entities exactly as they would in the real world. This stringent time requirement has prevented the use of high fidelity 3-D visualization applications in most simulation applications.

On the other hand, the computational portion of modeling and simulation has become such a common practice in science and engineering applications; it has been used to formulate concepts, aid the design tasks, test the designs, and perform full-life cycle support for products. Modeling and simulation, when used efficiently and effectively, can cut down the development time with minimal resources. Scott James' article “Simulation-centric Processes for Aerospace” from the January 2005 article of the In Journal of Embedded Systems Programming, provides a description of various methods of improving the design cycle, and is herby incorporated by reference. The real-time visualization can add more depth of understanding to enhance modeling and simulation. Visualization, when properly presented, can provide an unambiguous means for communication that can enhance understanding to the level that even laymen can easily and quickly comprehend.

In the past few years, engineers have used computer visualization to demonstrate the results of physics based modeling and simulation, product development and for marketing purposes with great success. Many techniques, processes and methodologies have evolved out of the use of this technology. The physics based modeling and simulation applications range from the production of virtual prototypes (VPs, the digital representation of design prototypes), the test of the VPs in different virtual environments, up to the simulation of VPs in simulated scenarios. Another salient feature is that in a large-scale simulation, it is not uncommon to have a hybrid setup of computer generated simulation models interoperating with real systems either in a real or virtual environment. These hybrid simulations, also called hardware-in-the-loop/operator-in-the-loop, provide very convincing results other than just pure numerical analysis. These hybrid simulations have been successfully used as lab based test sets.

For many modeling and simulation tasks that require real-time visualization, the engineers simulated the operation of a design in a simulated virtual environment, or even simulated how the design would operate under various conditions and environment. To refine the design or testing tactics, many minor modifications are performed in real-time in various simulated environments during the simulation process. In the past, each time a different scenario or minor change was called upon it would require modification of the computer visualization code and recompilation; even when the same simulation tools were used again and again. For a standard project of this nature, most effort was spent in the production of computer visualization and many of those visualization software components were seldom re-useable. Therefore there is a need for a simulation tool with the capacity for versatile real-time visualization.

### SUMMARY OF THE INVENTION

The present invention demonstrates that almost any physics based simulation can be depicted using real-time visualization. Modular client-server type software architecture was introduced to take advantage of distributed computing. This approach allows the simulation and visualization to run on different computing platforms and distributes the heavy computational load over several machines. Through the use of software hooks in the simulation application with a wide variety of communication protocols, almost any physics based simulation can be tied into the system for real-time visualization. The combination of complex physical simulations and realistic real-time interactive virtual environments provides engineers with a means to test the design in various environments before finishing the final product(s), and program management with a means for better communication and measurement of progress. Customers objectively know what they will receive by test driving the product before the designers complete the design.

The present invention describes a system that combines complex physical simulations with a real-time visualization software tool, and displays the results in realistic 3D environments. The Generic Visualization System (GVS) displays the combined results of many different simulation programs, including several Semi-Automated Forces (SAF) variations (e.g., OneSAF, JSAF, and others), simultaneously. GVS can display any kind of data with any type of reference coordinate system. Data can be referenced to Earth or referenced to other objects, such as in the sequencing simulation for an ammunition handling system. In that respect, GVS is a more generic system with a finer level of granularity than the prior art as it can simulate all interacting components of a system and subsystem as well as show a high level overview of entities moving along the terrain.

GVS has the capability to co-simulate entities from multiple simulation feeds, such as multiple Federated Object Models (FOM). In a complex co-simulated environment GVS can visualize the position data for one or more entities from multiple SAFs and dedicate auxiliary simulations to compute the internal operations of components for each entity. For example, SAF provides position data for the Non-Line of Sight Cannon (NLOS-C) and the client provides position data for NLOS-C internally moving parts. GVS has the capability to visualize large scale scenarios, as well as low level detail for each entity.

GVS is not bound by a specific rendering engine, but provides an API for a set of COTS rendering engines such as Delta3D, Ogre3D and VegaPrime. By not limiting GVS to a specific renderer, graphics upgrades require a rendering engine upgrade and potentially minor internal message processing updates to handle new special effects and visual functionality. GVS has the capability to utilize a wide range of rendering engines available on the market making it more versatile than other visualization systems. By doing so, GVS also has the advantage of focusing resources on interface enhancements and let third-party companies focus on enhancing graphics and optimizing rendering techniques to utilize advanced techniques for the newer generation rendering hardware.

Unlike the prior art, GVS utilizes strong encryption techniques for all communication. This allows GVS clients and server to be geographically separated without compromising security and data integrity. Furthermore, the GVS clients can, but do not necessarily, have to be geographically separated from the GVS server. This allows the data preprocessing to happen on the client side and only GVS messages to be sent back to the server. This technique minimizes network utilization, especially for large scale scenarios.

GVS can handle a multitude of coordinate systems (for example: Geodetic, , Geocentric, Cartesian, MGRS, UTM, Orthographic, Mercator, F-16 Grid Reference System), ellipsoids, and Datums (for example: WGS-84, WGS-72, NAD-83, Korean Geo Datum 95, Ordnance GB36, European 1950). Conversion between these and a multitude of other coordinate systems can be performed within the GVS to provide a reference coordinate system. GVS can also simulate position error and propagated error between coordinate systems (i.e. for non-differential GPS positioning data).

For large-scale simulation, many of those modeling and simulation activities are based on commonly used simulation packages such as various SAF (ModSAF, JSAF, OneSAF, and OneSAF Test Bed [OTB]) and mission specific simulation programs. Most simulation activities involve the interaction of several simulated entities. At times, a hybrid simulation environment also calls for real-time inputs from human operators or hardware-in-the-loop entities. For convenience and uniformity, the communication between different nodes, most frequently used, is HLA/DIS (High-Level Architecture/Distributed Interactive Simulation) compliant. A powerful visualization software package is required to provide 3-D visualization for the results from this kind of simulation. For example, a basic visualization software package such as Multigen's VegaPrime API. For this reason, the new real-time visualization software design has a modular framework that supports VegaPrime and can be modified for other visualization software applications. The interfaces between this real-time visualization software, GVS, and other simulation packages, have to be transparent and easy to use.

The present invention provides a method to overcome numerous technical obstacles to achieve this real-time visualization capability. Many popular large-scale simulations have multiple vignettes describing multiple events or objects coexisting at the same instance in time and being simulated by the same program. Those frame rate locked time driven simulations will most likely not follow the ad hoc 30-frame-per-second standard for real-time visualization. For example, to show how a group of vehicles is moving on a terrain, driven by the output from a SAF simulation, some of the vehicles may move smoothly while others may jump erratically. This phenomenon is caused by the uneven integration steps in the simulation program and different time references for the various entities in the simulation. To overcome this issue, Coordinated Universal Time (UTC) is used as the standard time reference for dead reckoning algorithms, which smooth the movements of all the entities in the simulation.

Another difficulty encountered while developing the real-time visualization involves the large number of terrain datasets and physical objects to cover a wide spectrum of the simulation. The commonly used DTED (Digital Terrain Elevation Data) or DEM (Digital Elevation Model) data does not include the entire world terrain in high resolution. The problem is partially resolved by creating a process to load a low level world terrain database at start-up. When the need for a specific high resolution terrain cell is not in the DTED or DEM repository, then the low resolution terrain may be used to produce an approximate 3-D terrain model first, and cover it with a matching texture in order to mimic the actual terrain. This solution can be an entirely manual process or may be automated.

One limit of the system is the size of the scenario simulated. It is evident that the world with every speck of sand or every leaf on a tree cannot be simulated because of the limits in database size and the level of effort such an undertaking would require. Also, it is not possible to simulate all possible outcomes from any scenario, since the results are non-deterministic in nature. Also, it is not possible to have an unlimited database for a virtual environment (terrain, for example) and unlimited objects (many new systems will appear as time goes by), the present invention provides the flexibility to create those missing pieces rapidly if they do not exist in the GVS database. For distributed applications, a centralized database can provide the data for the display to each site. Using a distributed architecture; multiple systems minimize network transfer time delay. While the transferring of high volume data may slow down network traffic and hamper real-time operation, the GVS may not provide a complete real-time computer visualization solution for very large simulations, but it may be used as bridging technology for the purpose it is intended for. It will be a very powerful tool for after action review and a convenient tool for the construction of trainers and training. The salient feature of the GVS is to provide a multi-dimensional representation of almost any physics based simulation.

### BRIEF DESCRIPTION OF THE DRAWINGS

FIG. 1 shows the basic architecture of the GVS and the external interfaces.

FIG. 2 is a schematic showing the rendering engine is isolated from the GVS core layer in the GVS system architecture.

FIG. 3 is a flowchart illustrating the general start-up and processing steps of the GVS server.

FIG. 4 is a flowchart illustrating the process of interpolating the position of simulated objects that is performed by the GVS server.

FIG. 5 is a flowchart illustrating the general start-up and processing steps of a generic GVS client.

FIG. 6 is a flowchart illustrating the encoded communication system.

### DETAILED DESCRIPTION OF THE DRAWINGS

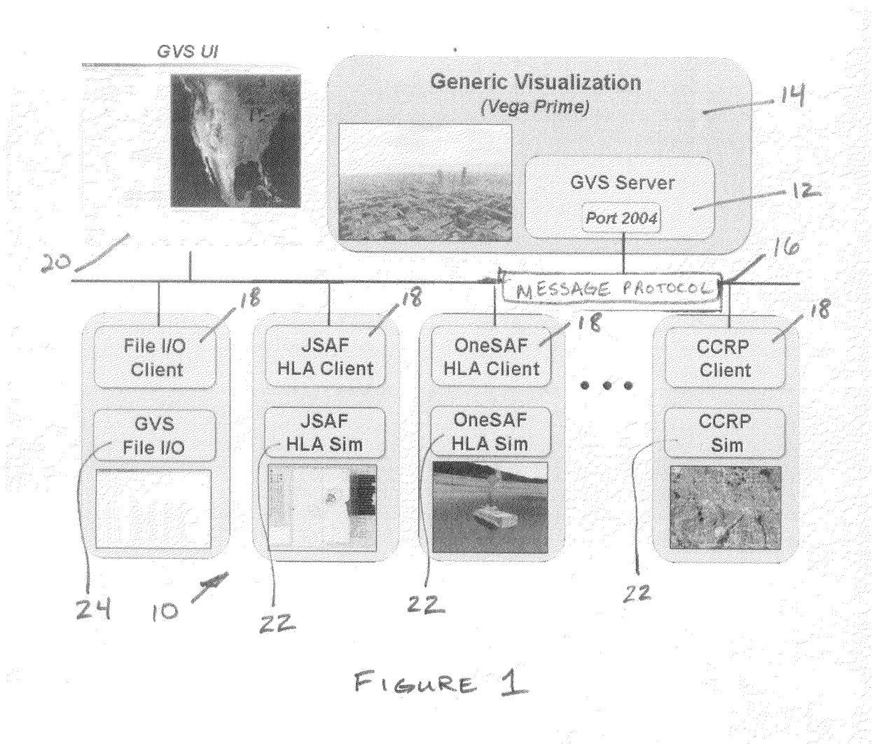

The software architecture of this real-time visualization system 10 is shown in FIG. 1. A GVS server 12 was constructed for the 3D visualization and resides on the same platform (or multiple platforms when such a need arises) as the visualization software package 14. A GVS client 18 application is written for each digital simulation and can reside either on the visualization platform or the simulation platform. A User Datagram Protocol (UDP) connection 16 was then made between the GVS server 12 and the GVS client(s) 18 for the transfer of data from the digital simulations to the 3D visualization environment. The underlying model used in this process is a physics-based model where the data from the digital simulations drive the entities in the 3D visualization environment. A separate software entity called the GVS User Interface (UI) 20 is operated by the user to control the GVS system 10. This GVS User Interface 20 also allows interactive operation with the GVS visualization software 14. It receives the input directly from the operator and sends external event input parameters to the GVS server 12. This feature is a powerful and convenient tool for the construction of computer-based trainers when such need arises. Management and customers can understand what the end product will look like and how it will perform in various scenarios through the means of a movie-like real-time visualization. Future system users can use either the keyboard (and mouse) or controller mockup for system training (e.g. an airplane cockpit, a vehicle, or a module of a mechanism). The GVS observer orientation and position can be controlled by keyboard input, sometimes referenced as hotkeys or by external devices (such as joystick, data glove, etc.,).

The system network architecture shown in FIG. 1 illustrates the Generic Visualization System (GVS) client/server architecture 10, where the visualization is performed by the server 12 and the digital simulations are the clients 18, for example: GVS File I/O, Joint Gun Effectiveness Model (JGEM), SAF HLA, Gun Sequencer. One type of digital simulation the system can interface with is the High-Level Architecture (HLA) 22 type of simulation. The Federate Object Model (FOM) in an HLA simulation 22 describes the attributes of objects and interactions between objects in the simulation. Every HLA simulation 22 has a different FOM; therefore, the present invention includes the ability to rapidly create clients to connect to multiple HLA simulations 22. In one potential embodiment of the invention a Java client code generator can be used to rapidly create these HLA clients for the GVS simulation.

The GVS architecture 10 includes a User Interface (UI) and 2D-Map 20. The GVS UI 20 consists of multiple configuration panels controlling various GVS visualization software 14 settings for the environment, observer, entities and simulation control. In addition to the configuration panels, the UI 20 has a notional 2D overview map of all simulated entities in the GVS visualization software 14. The UI 20 connects to the GVS visualization software 14 using a client/server architecture and can be geographically separated.

The GVS visualization software 14 can also interface with the Distributed Interactive Simulation (DIS) type of simulation. Similar to the HLA and DIS interfaces, data is sent to the GVS server 12 from external simulations in real time. The File I/O interface 24 allows GVS visualization software 14 to visualize entities from files or databases. Each input file can be generated by an external simulation in its own proprietary data format. The purpose of the GVS File I/O client 18 is to read in the external file, map the entity events to the GVS visualization software 14 corresponding event types and send them to the GVS server 12 for visualization. GVS visualization software 14 source code has been written in ANSI standard C++ and Java without Windows specific library calls to improve cross-platform and operating system compatibility. The GVS server 12 can be compiled and run on different platforms, such as Microsoft Windows and Linux. The UI 20 was written exclusively in Java, which runs on any machine with a Java Runtime Environment.

A message protocol 16 exists for communication between the individual clients 18 and the GVS server 12. There are three different message or communication protocols between the clients 18 and the GVS server 12. The first is a reliable communication protocol, Terminal Control Protocol (TCP), which not only guarantees that all packets were received by the server, but also provides built-in means for error correction and retransmission, should any of the packets get dropped during high network utilization. The other is the User Datagram Protocol (UDP), which requires less communication and processing overhead, but does not guarantee delivery to the server. Most of the clients 18 are currently configured to run in UDP mode, since the GVS server 12 handles missing data packets by extrapolating entity states and by utilizing dead-reckoning algorithms to anticipate the positions of entities. In addition, an encrypted XML message may be used.

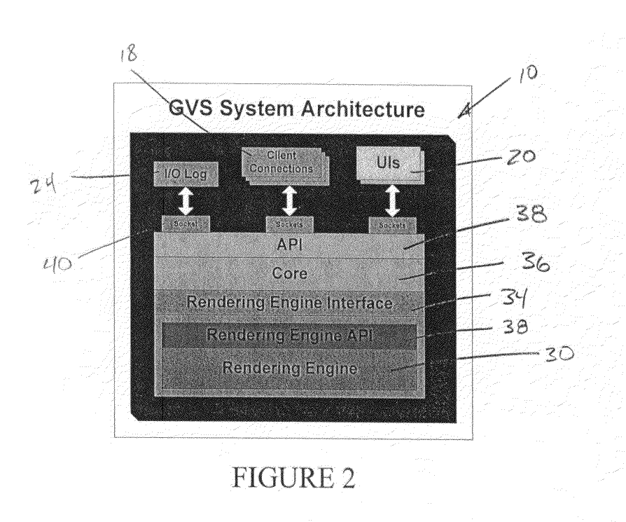

As illustrated in FIG. 2, the rendering engine 30 is isolated from the GVS core layer 36 in the GVS system architecture 10. All file loggers 24 and client connections 18 communicate via the application interface (API) 38 to the GVS core 36, which sends all entity information to be rendered down to the rendering engine interface 34. The rendering engine 30 itself is a self contained entity and has its own API 38. By isolating the rendering engine 30 from the GVS core 36, third-party rendering engines can be swapped out with newer ones as they become available. For example, one present embodiment of the invention is designed to support both the OGRE Team, Ogre3D (http://www.ogre3d.org/) and the MultiGen-Paradigm, Inc. Vega Prime (http://www.multigen.com/products/runtime/vega_prime/index.shtml) rendering engines.

The present invention includes the ability for special effects handling. For example, with the MultiGen-Paradigm, Inc., Vega Prime rendering engine 30, special effects are event message types sent from the GVS clients 18 to the GVS API 38 to display special effects. GVS architecture 10 supports a wide variety of special effects and includes, but is not exclusive to, effects of smoke, explosions, marine bow waves, marine hull wakes, fire, splashes, debris, flak, rotating blades, missile trails and muzzle flash. GVS architecture 10 also has the capability to visualize sensor effects provided with the VegaPrime real-time rendering engine, which include Blur, Multiplicative and Additive Fixed Pattern Noise, Saturation, Random Temporal Noise, Sampling Artifacts, Automatic and Manual Gain and Level, Polarity Inversion, Jitter, Light-Point Blooming, Phosphor Persistence, AC Coupling and Scintillation.

In order for the GVS architecture 10 to be able to visualize various simulated entities from different simulations, entity data must be converted to a common format. This task is performed by the GVS clients 18, which convert the proprietary messages from other simulations to GVS standard messages that are sent back to the GVS API 38 for visualization. The GVS client 18, utilizing a message mapping scheme, is the gateway between both systems and can reside anywhere on the network. The communication infrastructure between the clients 18 and GVS architecture 10 is based on a client/server architecture, were several clients 18 can simultaneously connect and send data to the server 12 via a communication network (such as a common TCP/IP network). The file logger and the Graphical User Interface (GUI) communicate with the server 12 in the same way. By utilizing this architecture, the system is highly scalable and system components are geographically independent, giving the user more control and flexibility.

The present invention also allows for entity data saving and playback. The data traffic being sent from the various clients 18 to the GVS visualization software 14 can be recorded and saved to file for later playback. The individual data sources as well as the other culling parameters can be set via the GVS user interface (UI) 20 to limit the amount of data stored. A scenario playback file can be loaded via the UT 20 and run from within the GVS visualization software 14. Since the data is not being run in real time, the simulation can be run at higher rates than 1×. Also, playback controls such as stop, play, pause and a time scalar slider can be used to control playback from within the UI 20. Scenarios can also be recorded and views stored as audio video (AVI) movie files or individual frames.

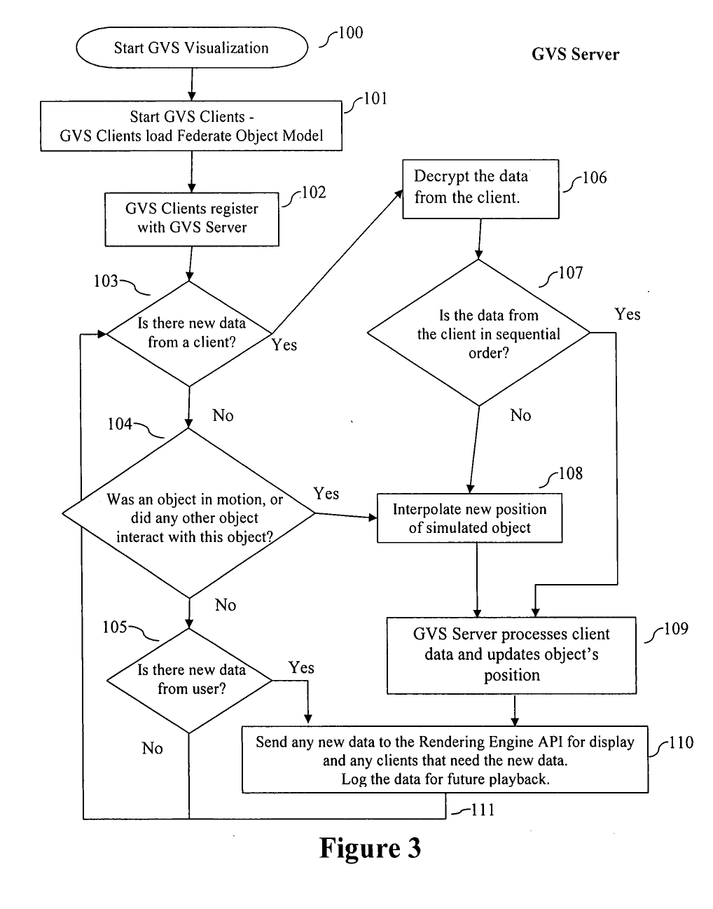

FIG. 3 depicts the general start-up and operational steps of the GVS server 12. The GVS start-up procedure includes: starting all of the internal GVS server core 36 processes, creating the application interfaces to the GVS UI 20 and the Rendering Engine API, shown by the visualization start-up block 100. The client start-up block 101 includes the initialization all of the necessary GVS clients 18 and creating the connections to each client 18 follows immediately after the visualization start-up block 100. The GVS server 12 must wait for each client 18 to register with the GVS server 12 as shown in the registration block 102. One possible embodiment of the invention could allow the user to add new clients 18, or remove a currently registered client 18, from the GVS simulation after the simulation has been started. This would allow the user to add or remove simulated objects or elements to the simulation as it progresses to either add or remove fidelity from the scenario currently being simulated.

After a simulation has been started the GVS server 12 must continually monitor the clients 18 in order to receive the latest information on each object that is being simulated. In one possible embodiment, the GVS server 12 could require the clients 18 to asynchronously send the server 12 new data whenever the client 18 has fresh information. The GVS server 12 would periodically check for new client data as shown in decision block 103. Alternatively, the GVS server 12 could request new information from the clients 18 on an as needed basis. Because all data between the GVS server 12 and the GVS clients 18 is encrypted, any new data must be decrypted by a client decryption algorithm 106 before it can be used.

Coordinated Universal Time (UTC) is used as a time stamp on every message the GVS simulation server 12 receives. This technique will synchronize message streams from multiple simulations connecting to the GVS sockets 40. The UDP packets received from simulations are not guaranteed to arrive in order; therefore the UTC timestamp will be used to chronologically sort the messages coming into the GVS server 12.

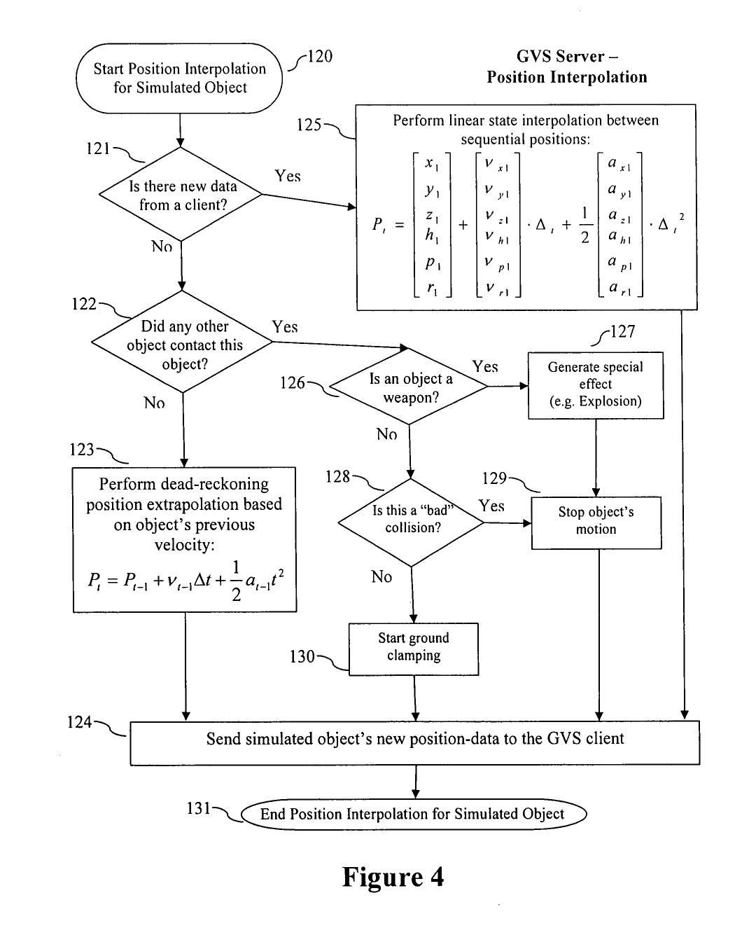

When any new data is received from the client 18 the GVS server 12 must check to verify that the data is in the proper order as shown in decision block 107. If the data is not in the proper order, the GVS server 12 needs to update the objects position in order to meet the frame refresh rate requirements, the GVS server 12 will access the interpolation algorithms 108 to calculate a new position for the simulated object. The position interpolation process is further described in FIG. 4.

The GVS server 12 must also be aware of any input from the user that would effect the position or other attributes of a simulated entity. When each simulated element is updated the GVS server 12 will check, as shown in decision block 105, to see if any user originated commands have been received through the GVS UI 20. Once a new status for a simulated element is present and valid the GVS server 12 must update its internal representation of that object in processing block 109 so that it can determine if there are any new interactions between this element and the rest of the simulated environment. Any new data is the sent to the rendering engine 30 and logged for future playback 110 by the GVS server 12. When this sequence is complete the GVS server 12 will repeat the process as shown by branch 111 for every simulated element or in another potential embodiment the GVS server 12 will process the next element that it determines through a priority scheme that must be updated.

FIG. 4 depicts the position interpolation algorithms used to enable smooth movement of entities within the GVS architecture 10 when no new position data is available. Since the GVS architecture 10 typically runs at thirty or more frames-per-second (fps), but positioning data from certain external simulators arrives in one second intervals, there is a need for interpolation by the GVS server 12.

There are two algorithms for data position interpolation. The first is linear state interpolation wherein two chronologically sequential positions updates are calculated regardless of the motion of the vehicle. This linear state interpolation algorithm interpolates linearly between all six degrees of freedom (x, y, z, h, p, r) and determines in-between positions for the entity.

$${P}_{t} = [ \begin{matrix}{x}_{1} \\ {y}_{1} \\ {z}_{1} \\ {h}_{1} \\ {p}_{1} \\ {r}_{1}\end{matrix} ] + [ \begin{matrix}{v}_{x 1} \\ {v}_{y 1} \\ {v}_{z 1} \\ {v}_{h 1} \\ {v}_{p 1} \\ {v}_{r 1}\end{matrix} ] \cdot {Δ}_{t} + \frac{1}{2} [ \begin{matrix}{a}_{x 1} \\ {a}_{y 1} \\ {a}_{z 1} \\ {a}_{h 1} \\ {a}_{p 1} \\ {a}_{r 1}\end{matrix} ] \cdot {Δ}_{t}^{2}$$

$$P = position ( x , y , z , h , p , r )$$

$$v = velocity$$

$$a = acceleration$$

$$t = time$$

The process begins when the GVS server 12 starts the position interpolation process in start-up block 120. The linear interpolation algorithm block 125 is used when the GVS server 12 must interpolate an objects position based on two different positions that were provided by the GVS client 18 in block 121.

The GVS server 12 is also continuously monitoring for collisions between simulated objects in decision block 122, including collisions between a simulated object and the terrain the simulation is taking place on. A special circumstance exists when an object that is a weapon, such as a bullet or missile, contacts another object. These special circumstances are monitored by decision block 126. Depending on the parameters of the simulation, this contact may result in the display of a special effect 127 such as the destruction of the object, and require the object to stop all motion 129. Not all collisions may be bad enough to cause the destruction of an object. These secondary collisions are monitored by decision block 128. A bad collision may require the object to stop all motion 129, but in some cases the objects may simply be required to follow the ground terrain (ground clamping—block 130) as in when an aircraft lands on a runway after a controlled descent.

The second algorithm utilizes dead-reckoning to determine new entity positions during the absence of position updates as described in the dead-reckoning block 123. Unlike linear interpolation 125, dead-reckoning extrapolates future positions of an entity base on its previous velocity vectors and acceleration using simple kinematic equations:

$${P}_{t} = {P}_{t - 1} + {v}_{t - 1} Δ t + \frac{1}{2} {a}_{t - 1} {t}^{2}$$

Whenever the GVS server 12 interpolates the position of a client object, or stops or changes the parameter of an object's motion, a position-data message 124 must be sent back to the GVS client 18 in order to keep the simulation calculations consistent. Once this position-data message 124 is sent the interpolation process is complete as shown by the process terminator 131.

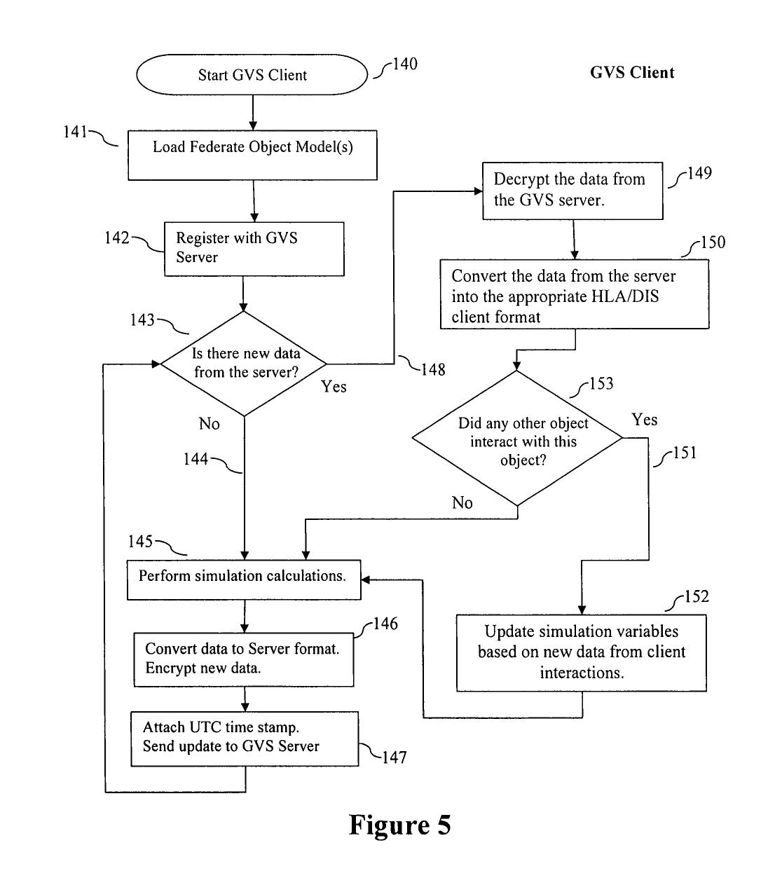

FIG. 5 depicts how the GVS clients 18 initialize, process data, and interacts with the GVS server 12. Each GVS Client 18 can be started individually. The GVS client 18 acts as a wrapper around the individual HLA simulations in order to provide connectivity with the GVS server 12. Once the GVS client 18 has been initialized in start-up block 140 it must load the FOM for the HLA simulation as shown in loading block 141. Each FOM describes the attributes of objects and interactions between objects that will be calculated by the GVS client 18 for the simulation. When all of the GVS client's 18 FOM data is loaded and ready to begin performing calculations the client 18 must send a registration message 142 to the GVS server 12.

Once the simulation has started, the GVS client 18 must continually interact with the GVS server 12. FIG. 5 also depicts these ongoing interactions. Each GVS client 18 must continuously be prepared to receive communications, as show in decision block 143, from the GVS server 12 that would affect the client's simulation calculations. If no new data is received the client 18 follows branch 144 and continues to perform any necessary calculations 145 related to the object under simulation. This calculated data will be periodically encrypted 146, given a UTC time stamp, and then sent as a message 147 to the GVS server 12. In the situations where new data is received from the GVS server 12 the client 18 follows branch 148 where data must is decrypted in block 149, and then converted from the generic GVS format into the appropriate HLA/DIS format for the client 18 in block 150. The client 18 must then check for any interactions with other object n the new data in decision block 153. If data from the GVS server 12 indicates that there are interactions with other simulated object the client 18 follows branch 151 and must update the client's 18 simulation variables in block 152 to reflect this input. Possible interactions could include collisions or the incapacitation of the simulated object requiring that the simulation stop all movement, or change the direction or speed of moment in the simulation. After the update is completed the client 18 will continue with the normal calculations in block 145.

CDOF is a GVS class used to manipulate Degree Of Freedom (DOF) articulated parts. DOF articulated parts are in the hierarchy of a 3D model allowing for movement of jointed parts in the x, y and z directions and heading, pitch and roll orientations. For example a turret on a tank is an articulated part that can be moved separately from the tank hull. CSwitch is a GVS class used to turn on or off the visualization of 3D models or any parts in the model hierarchy. This toggle can be embedded within the hierarchy of a model to show different model states. For example a tank can be in a healthy state or destroyed state. A scalar class allows for the scaling of entities during visualization.

The present invention has the capability to mark the Forces Side Support (e.g. Red Team/Blue Team) on the simulated entities in the visualization display that is presented to the user. In HLA or DIS simulations, entities are marked with a “side_flag” parameter to identify it as being hostile, friendly or neutral. The GVS architecture 10 can display a flag above the entity that reflects its “side_flag” parameter. Moreover, The GVS architecture 10 has a capability to display a second video channel that is used to stream frame data to an external simulation for use in an out-the-window view (i.e. cockpit or periscope view).

The GVS architecture 10, as illustrated in FIG. 2, includes an encryption algorithm for communication protocol. Communication between GVS server 12 and the clients 18 is encrypted using the following public key encryption system. First key generation and exchange must be established. GVS server 12 uses a public key encryption scheme, incorporating the advanced encryption standard (AES) (FIPS-197) based on the Matyas-Meyer-Oseas hash algorithm (MMO) and the digital signature algorithm (DSA) (FIPS-186) based on the secure hash algorithm −1 (SHA1) (FIPS-180). All communication between the GVS server 12 and the clients 18 must be encrypted to ensure confidentiality. The present invention utilizes an AES-256 bit, a 256 bit symmetric key block cipher permutation algorithm. The symmetric encryption key for AES-256 is generated via a Diffie-Hellman (DHKA) key agreement in the following way (F denotes the client and R denotes the server):
p=prime
α is a generator of Z*ₚ, {α: 2≦α≦p−2}
(step1)F→R:α^{(x|1≦x≦p-2)} mod p
(step2)R→F:α^{(y|1≦y≦p-2)} mod p
Common Keys:
(step3)PK_{F}=(α^{x})^{y} mod p
(step3)PK_{R}=(α^{y})^{x} mod p
   Since AES-256 requires a 256 bit key and DHKA does not guarantee a key size of 256 bit length, we need to apply a hash function that reduces or expands the key size to 256 bit. The algorithm we use to perform hashing of the AES key is MMO-256.

Having established the keys necessary for the AES block cipher algorithm, data integrity must be ensured. This can be accomplished with a digital signature, for example the DSA and SHA-1 algorithms.

DSA requires the following public keys:
y,p,q,g
y=g^{x} mod p
p=prime:2^{L-1}<p<2^{L},{L:(512≦L≦1024),(L|64)}
q=prime:{q:2¹⁵⁹<q<2¹⁶⁰}

$$g = {h}^{\frac{p - 1}{q}} mod p , \{ h : 1 < h < p - 1 \}$$

And the following private keys:
x,k
{x:(0<rand(x)<q)}
{k:(0<rand(k)<q)}

The signature S(r,s) is the following:
S(r,s)|r:(g^{k} mod p)mod q,s: [h_{SHA1}(m)+rx]mod q}

The hashing function SHA transforms the message m into a 160 bit hash so it can be used with DSA. All above mentioned public keys—PK, p, q, g, y for DSA and SK for AES—are pre-distributed to the client system.

Next, the present invention provides a method for secure HLA communication. Now that the group keys have been established the clients 18 and the GVS server 12 can exchange data via the following algorithm:
⊕ denotes a bitwise XOR operation

$$F \to R : {E}_{{R}_{hMMO - {256}_{AES - {256}_{SK}}}} ( m ⊕ γ , γ ) , {S}_{DSA} ( {r}_{F} , {s}_{R} ) \vert \{ γ : γ = rand ( ) \}$$

$$F \to R : {E}_{{R}_{hMMO - {256}_{AES - {256}_{[ {( {a}^{x} )}^{y} mod p ]}}}} ( m ⊕ γ , γ ) , {S}_{DSA} ( {g}^{k} mod p , {k}^{- 1} ( {h}_{SHA 1} ( m ) + xr ) mod q ) \vert \{ γ : γ = rand ( ) \}$$

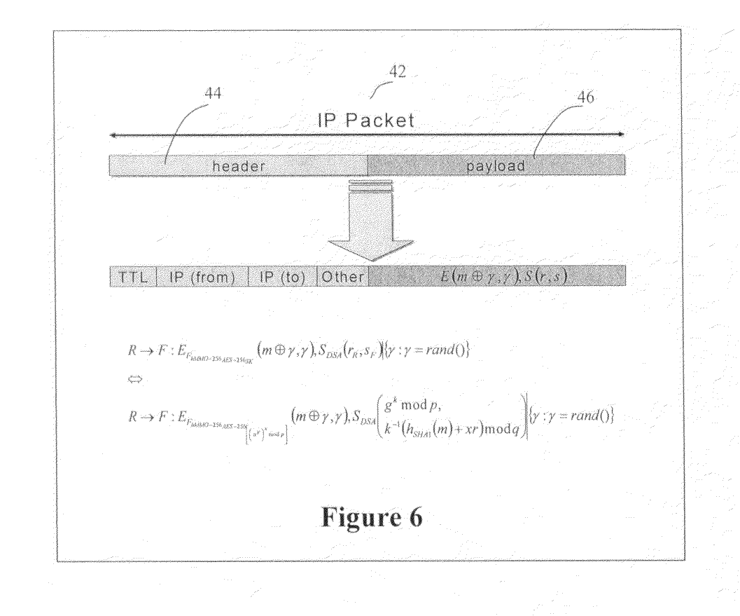

The ⊕ operation of the message with a random value is necessary so that no two plain text messages have the same corresponding cipher text. The client 18 may communicate with the GVS server 12 as follows in FIG. 6 wherein the IP packet 42 is separated into header 44 and payload 46.

In order to maintain optimal network performance the present invention may include a complexity analysis and optimization method. The timing complexity of all encoding operations will lead to some network performance deterioration. Most of this is attributable to the most time consuming operations, which are the exponentiation operations, two of which are performed repeatedly for DSA and the other two, AES_{PK} (large exponents!) and r_{R} or r_{F}, which can be pre-computed to conserve computational resources. Further optimization can be performed by also pre-computing k⁻¹ for DSA. The present invention uses well defined encryption standards, so as to allow hardware with built in solid-state cryptographic finite-state machines or NIC cards with built in cryptographic capability to offload some of the processing power from the central processing unit(s). Table 1 outlines the strength and attack vulnerabilities of each hash algorithm:

TABLE 1

| | SHA1 | MMO |
|---|---|---|
| | Strength | Strength |
| pre-image resistant | yes | yes |
| | 2¹⁶⁰ | 2²⁵⁶ |
| 2^{nd} pre-image resistant | yes | yes |
| collision resistant | yes | yes |
| | 2⁸⁰ | 2¹²⁸ |

### MMO is the only unkeyed hash algorithm that is resistant to all three attacks and produces the 256 bit resulting hashes needed for AES.

Within the simulation visualization, GVS visualization software 14 has the capability to show NATO standard tactical symbology to identify the type of individual units. These symbols can be toggled on/off via hot key or from the UI 20 and are determined by the entity type field in the GVS message. In the 3D view, these symbols are of billboard type and hover over the unit. On the 2D UI map, these symbols are overlaid onto the map background image and scaled proportionately.

GVS visualization software 14 incorporates geospatially accurately modeled culture, such as building shapes taken from LIDAR (Light Detection and Ranging) measurement data, GIS (Geographic Information System) road maps from public sources such as USGS (US Geological Survey), road infrastructure, such as bridges and road types, and vegetation types such as forests, prairies and farm land.

Therefore, the foregoing is considered as illustrative only of the principles of the invention. Further, since numerous modifications and changes will readily occur to those skilled in the art, it is not desired to limit the invention to the exact construction and operation as shown and described and accordingly all suitable modifications and equivalents may be resorted to, falling within the scope of the invention.

1. A generic visualization system for depicting the results of a simulation in a real-time mode, the system comprising:
a generic visualization server coupled by a network to a multitude of clients, the clients including at least one simulation program and at least one input file, the generic visualization server capable of integrating the output of multiple clients to simultaneously create a composite scenario in a single environment, passing data based on an integrated composite scenario to a generic visualization rendering software package capable of animating the output of at least one simulation program; and
a user-interface operably connected to the generic visualization server, the user-interface including at least one configuration panel, at least one visualization display, and an overview map.

2. The system of claim 1, wherein the user-interface can display the composite scenario in the single environment from a plurality of perspectives.

3. The system of claim 1, wherein the clients operate on a plurality of computer systems.

4. The system of claim 3, wherein the computer systems are located in a plurality of physical locations.

5. The system of claim 1, wherein the clients transmit and receive data over the network through the use of a User Datagram Protocol (UDP) connection.

6. The system of claim 1, wherein the clients transmit and receive data over the network through the use of a Terminal Control Protocol (TCP) connection.

7. The system of claim 1, wherein the communication between the generic visualization server and the clients over the network utilizes an encryption system.

8. The system of claim 7, wherein the encryption system uses a public key encryption scheme, incorporating the advanced encryption standard (AES) based on the Matyas-Meyer-Oseas hash algorithm (MMO) and the digital signature algorithm (DSA) based on the secure hash algorithm-1 (SHA 1).

9. The system of claim 1, wherein the simulation program is a High Level Architecture (HLA) type of program.

10. The system of claim 1, wherein the simulation program is a Distributed Interactive Simulation (DIS) type of program.

11. The system of claim 1, wherein the generic visualization rendering software package is isolated from the generic visualization server, the generic visualization server sends communications to the generic visualization rendering software package through a rendering engine application interface.

12. The system of claim 1, wherein the generic visualization server includes at least one position interpolation algorithm to smooth the displayed movement of a simulation client program's output that is provided to the server at less than 30 frames per second.

13. The system of claim 12, wherein the position interpolation is performed by a linear state algorithm which interpolates linearly between six degrees of freedom for two chronologically sequential position updates.

14. The system of claim 12, wherein the position interpolation is performed by a dead-reckoning algorithm that extrapolates a future position of an entity based on previous entity velocity and acceleration vectors.

15. The system of claim 1, wherein the physic based simulations utilize a plurality of coordinate systems; wherein each coordinate system must be converted to a single standard by the generic visualization system server for use by the generic visualization rendering software tool.

16. The system of claim 1, wherein the results of each simulation program is coordinated through the use of time-stamps based on Coordinated Universal Time; wherein when the results of the simulation programs are displayed in the proper order.

17. The system of claim 1, wherein the simulation program is replaced by one or more physical implementations of a device that is simulated; wherein an operator is able to interact with the device; and affect the results of the simulation in real-time.

18. The system of claim 1, wherein the user-interface displays multiple views of the simulation in real-time.

19. The system of claim 1, wherein the user-interface displays multiple views of the simulation results in a movie format.

20. The system of claim 1, wherein the simulation programs that define the digital representation of a physical object are reusable.

21. The system of claim 1, wherein the simulation programs that define the digital representation of a physical object are comprised of a hierarchy of elements that can be controlled or displayed individually.

22. A method for integrating and displaying a plurality of simulations in real-time, the method including:
coupling a generic visualization server to a multitude of distributed client devices,
performing simulation calculations on at least one selected distributed device through a client program,
creating an I/O file from a database within the selected distributed device,
converting the output from the simulation to a common format,
converting the I/O file to a common format,
combining a plurality of different computer generated physical simulations in to a common framework, and
displaying the results of the simulations in real-time in a 3D display format with a generic software visualization tool.

23. The method of claim 22, further comprising a user-interface for interaction with the simulation in real-time.

24. The method of claim 22, wherein displaying the results includes interpolating position data by a linear state algorithm which interpolates linearly between six degrees of freedom for two chronologically sequential position updates, and by a dead-reckoning algorithm that extrapolates a future position of an entity based on previous entity velocity and acceleration vectors.

25. The method of claim 22, further comprising reusing a digital representation of physical objects in multiple simulations.

26. The method of claim 22, further comprising generating a client simulation code that is capable of operating on a variety of computer systems.

27. The method of claim 26, wherein the client simulation code is generated in the Java programming language.

28. The method of claim 22, wherein displaying the results includes simulating multiple world views.

29. The method of claim 28, wherein a simulation display rate is at least 30 frames per second.

30. The method of claim 22, further comprising interfacing real-time inputs from a human operator with a simulation.

31. The method of claim 22, further comprising generically interfacing the simulation software with the generic visualization software.

32. The method of claim 31, further comprising replacing the generic visualization software in the generic visualization system with an alternate generic visualization software.

33. A method for performing physics-based simulations, the method including:
dividing the simulation into a plurality of individual objects,
simulating individual objects with a plurality of discrete models,
organizing the individual objects through the use of a server program,
distributing each individual simulation object to a client program,
sending messages between each client program and the server program as the simulation progresses,
monitoring the interactions between the individual objects by the server program,
applying a set of rules to govern any interactions between the individual objects,
combining all of the client's communication containing a result of the individual object simulations into an aggregate simulation result,
presenting the results of the simulation in a graphical format.

34. The method of claim 33, wherein the results of the client program simulations are interpolated to compensate for any missing data.

35. The method of claim 34, wherein the results of the simulation are presented at a rate of at least 30 frames per second.

36. The method of claim 33, wherein the client program for the individual simulation objects executes on a computer system that is connected to the computer system of the server program through a network.

37. The method of claim 33, wherein presenting the results includes a geospatially accurately modeled environment.
